(19) United States
(12) Patent Application Publication
(10) Pub. No.: US 2024/0328447 A1
(43) Pub. Date: Oct. 3, 2024

(54) JOINT SYSTEM

(71) Applicant: Dougan H. Clarke, Miami, FL (US)

(72) Inventor: Dougan H. Clarke, Miami, FL (US)

(21) Appl. No.: 18/621,491

(22) Filed: Mar. 29, 2024

Related U.S. Application Data
(60) Provisional application No. 63/455,547, filed on Mar. 29, 2023.

(51) Int. Cl. F16B 12/44; F16B 13/04

(52) U.S. Cl. CPC F16B 12/44; F16B 13/045; F16B 2012/446

(57) ABSTRACT

A joint system that allows for the modular assembly of furniture and enables such furniture to be made of metals or composites while providing for a seamless aesthetic design. The system can allow for furniture to mimic the appearance of wood or other textured materials, though it may be constructed of metals or polymers. The system features insert members, including flat and vertical types, each equipped with arms that contain channels, expansion members, and may contain a locking receptacle. The system can incorporate decorative elements that traverse/cover the bends/seams of the insert members, creating the appearance of decorative corners and enhancing aesthetic versatility. Structural supports are configured to slidably engage with the insert members, facilitating a straightforward assembly process. These supports can also connect to additional structural supports, further facilitating the construction of furniture.

### CROSS REFERENCE TO RELATED APPLICATION(S)

This application claims the benefit under 35 U.S.C. § 119 (e) to a U.S. Provisional Patent Application having Ser. No. 63/455,547 filed on Mar. 29, 2023. The above application is incorporated by reference herein in its entirety.

### BACKGROUND OF THE INVENTION

### Field

The present disclosure pertains to the field of structural assembly systems, focusing on assembling structures at the joints of such structural assembly systems. This disclosure is particularly relevant for the construction of furniture and similar structures, including furniture made from aluminum, other metals, plastics, or polymers. In addition, as this disclosure pertains to assembling structures, such as furniture designs at the joints of such designs, this disclosure pertains to the field of aesthetic and seamless furniture design.

### Description of the Related Art

In the realm of structural assembly and furniture design, traditional methods have long relied on techniques such as welding, adhesive bonding, and intensive mechanical fastening to join various materials, including metals, woods, plastics, and polymers together. These conventional approaches, while effective for certain applications, often present significant limitations in terms of design flexibility, aesthetic appeal, and ease of assembly. For instance, welding, a common method for joining metal components, requires specialized equipment and skilled labor/robotics, increasing production costs and limiting the ability to disassemble and reassemble structures for transportation or modification. These methods, while effective for achieving structural integrity, often restrict the design possibilities and complicate the assembly and disassembly processes, limiting the practicality of furniture for shipping and end-user assembly.

Moreover, the aesthetic integration of different materials, such as aluminum or polymers, to produce the classic appearance of wood, poses a challenge. Traditional methods struggle to seamlessly blend these materials in a manner that preserves the natural beauty and texture of wood while leveraging the durability and lightweight properties of metals and polymers. Essentially, traditional methods can introduce visual discontinuities that detract from the desired natural beauty of wooden furniture designs. Furthermore, the application of wood grain finishes to metal or polymer surfaces often fails to authentically replicate the appearance of natural wood grain, especially at connections where the continuity and alignment of the grain pattern are crucial for a convincing and aesthetically pleasing result. This limitation hampers innovation in furniture design, particularly in creating pieces that combine the best attributes of various materials.

The furniture industry, in particular, faces the challenge of balancing the demand for durable, weather-resistant, lightweight, and easily transportable products with consumer preferences for the warm, natural aesthetics of traditional wooden furniture with elegant design cues. The advent of flat-pack furniture has addressed some of these concerns by offering cost-effective, transportable options. However, the assembly process of such furniture often requires complex tools and fasteners that are not uniform, complicating the assembly process for end-users and restricting design possibilities for manufacturers. Moreover, flat pack type furniture does not currently provide for an aesthetically pleasing product that alludes to the appearance of traditional wood furniture.

The precision required in traditional joinery methods, such as miter joints, further complicates the manufacturing process. Achieving a snug fit between components requires exact measurements and cuts, which can be labor-intensive and prone to errors. This precision challenge is exacerbated when attempting to align and join components made from different materials, each with its unique properties and tolerances.

Current solutions also fall short in offering modular and adaptable design options. The ability to easily reconfigure or expand furniture pieces to adapt to changing needs and spaces is a desirable feature that traditional joining methods do not readily accommodate. In fact, today, the diversity in furniture design, ranging from sofas and chairs to coffee tables, necessitates a variety of joints and seams tailored to each piece's specific structural and aesthetic requirements. This variability introduces additional complexity into the manufacturing process, as each type of furniture demands distinct joining techniques that must align with its design, function, and load-bearing needs. Consequently, the need for a wide range of specialized joints and seams can exacerbate existing challenges in the furniture industry, complicating production lines, increasing costs, and limiting the ability to standardize components for streamlined assembly and design coherence. This fragmentation in manufacturing processes not only hinders efficiency but also constrains the potential for innovation in creating versatile, aesthetically unified furniture collections. This limitation restricts the versatility and potentially negatively affects the long-term value of furniture.

As previously alluded to, the transportation and assembly of furniture also present logistical challenges. Traditional assembly methods often result in bulky, rigid structures that are difficult and expensive to transport. The industry has made strides towards flat-pack designs that address these issues, but the need for a more integrated, tool-less assembly method remains largely unmet.

Such a solution would not only simplify the assembly process for end-users but also reduce shipping costs and environmental impact.

In light of these challenges, there is a clear need for an innovative approach to structural assembly that addresses the limitations of traditional methods. A system that offers flexibility in design, ease of assembly, adaptability to different furniture pieces, and the ability to seamlessly integrate different materials in a way that is both aesthetically pleasing and more easily transportable would represent a significant advancement in the field. The development of such a system would not only revolutionize furniture design and manufacturing but also provide a more adaptable, user-friendly solution for assembly and reconfiguration, catering to the evolving needs of consumers and the environment.

### SUMMARY OF THE INVENTION

The present disclosure describes a joint system with insert members. These insert members can have arms and decorative elements on their seams. The arms of the insert members can be encompassed by structural support members that can be made of metal or a polymer but can also be painted or otherwise decorated to look like wood. Using multiple insert members and structural support members, the present disclosure allows for the creation of shapes and designs for furniture as is shown in the Figures. In effect, the insert members paired with the structural support members can allow for decorative corners on these furniture and shape designs, while also giving the appearance that the furniture has no screw points or otherwise immediately apparent ways of visually determining how the designs/furniture was assembled/put together.

As such, onto a more technical summary as to the present disclosure, the present disclosure provides for a joint system comprising a flat insert member wherein the flat insert member comprises a decorative element, a fist arm, and a second arm. The first arm may comprise at least one channel having expansion members formed around the channel. The first arm may also comprise at least two locking receptacles. The second arm may also comprise at least one channel having expansion members formed around the second arm's channel. In addition, both the first and second arms of the flat insert member may comprise raised friction tabs formed on the exterior surface of the arms. Further, the arms may be coated with a substance to increase the frictional coefficients of the arms.

The channels of both the first and second arms of the flat insert member may be configured and dimensioned to receive an expander. At least one bolt (of many) may be configured and dimensioned to pass through at least one locking receptacle of the first arm to be inserted into the expander within the first arm's channel, and, when the bolt is rotated, the expander within the first arm's channel can apply a force to the channel, causing the channel's expansion members to expand. In a similar fashion, at least one bolt can be configured and dimensioned to pass through another (separate from the above) at least one locking receptacle of the first arm to be inserted into the expander within the second arm's at least one channel. When the bolt is rotated, the expander within the second arm's channel can also apply a force to the channel, also causing the channel of the second arm to expand through the expansion members expanding. In addition, the expansion members of each the first arm and the second arm may comprise at least one hook structure.

Continuing, the joint system may comprise at least two structural supports wherein one of the structural supports can be configured and dimensioned to slidably engage and enclose the first arm and the other structural support can be configured and dimensioned to slidably engage and enclose the second arm. The at least two structural supports can be made of metal, such as aluminum, or a polymer, such as a plastic. The structural supports can also be decorated with indicia so as to allow the structural supports to appear as natural wood. Moreover, each of the structural supports may comprise at least one hook structure (as is not imaged in the Figures) within the interior of the structural supports so as to correspond to the hook structure of the expansion members on the first and second arms. Moreover, the at least two structural supports may be configured and dimensioned to engage and enclose at least two other joint systems. In effect, multiple structural supports connected to multiple joint systems allows for the creation of designs and furniture (as will be subsequently described).

Further, the present disclosure also provides for a joint system comprising a vertical insert member. As may be apparent, the form and dimensioning of the vertical insert member may be distinct from the flat inset member. That said, the vertical insert may be higher similar in functionality and structure to the flat insert member. The vertical insert member (as well as the flat insert member) may have an insert reinforcement member configured and dimensioned to removably affix to and structurally reinforce the vertical insert member (or the flat insert member). The vertical insert member may also comprise a decorative element and a first and a second arm. The first and second arms of the vertical insert member may each comprise at least one channel having expansion members formed around the channel and at least one locking receptacle. In addition, each the first arm and the second arm of the vertical insert member may comprise raised friction tabs formed upon the exterior surface of the first arm and the second arm, as well as a substance coated to the exterior of first and second arm to increase the frictional coefficient of the arms.

Considering the vertical insert member, the first arm's at least one channel may be configured and dimensioned to receive an expander, where the second arm's at least one channel may also be configured and dimensioned to receive an expander. As such, at least one bolt may be configured and dimensioned to pass through the first arm's at least one locking receptacle to be inserted into the expander within the first arms at least one channel, and, when the bolt is rotated, the expander within the first arm's channel applies a force to the first arm's channel, causing the channel's expansion members to expand. Further, another at least one bolt may be configured and dimensioned to pass through the at least one locking receptacle of the second arm to be inserted into the expander within the second arm's at least one channel, and, when the at least one bolt is rotated, the expander within the second arm's at least one channel can apply a force to the channel, causing the expansion members to expand. Alternatively, the at least one bolt as immediately previously mentioned can be configured and dimensioned to pass through the channel of the second arm and inserted into the expander within the second arm's channel. When this bolt is rotated, the expander within the second arm's channel can then apply a force to the second arm's channel, causing the second arm's channel's expansion members to expand and causing the at least one bolt to partially, but not fully pass through the at least one locking receptacle of the first arm. Continuing, at least one expansion member of the first arm and at least one expansion member of the second arm may comprise at least one hook structure. Moreover, the instant joint system may comprise at least two structural supports where one of the structural supports may be configured and dimensioned to slidably engage and enclose the first arm and where another may be configured and dimensioned to slidably engage and enclose the second arm.

Lastly, the present disclosure also provides for a joint system that comprises at least one flat insert member, at least one flat structural support, at least one vertical insert member, and at least one vertical structural support. The at least one flat insert member and at least one vertical insert member may each comprise a decorative element that traverses the entire circumference of each insert member's respective seam. In addition, the at least one flat insert member and at least one vertical insert member may each comprise a first and second arm wherein the arms extend away from the aforementioned seam of each insert member. Further, each of the first and second arms of both the flat insert member and the vertical insert member may comprise hook structures at the end of each arm. Also, there may be means (as will be described, and as has been described) for expanding each the first arm and the second arm of the flat insert member and vertical insert member. In addition, each of the at least one flat insert member's first and second arms may be configured and dimensioned to slidably engage and be enclosed by at least one flat structural support where the at least one flat structural support comprises means for connecting with at least one vertical structural support. Further, each of the at least one vertical insert member's first and second arms may be configured and dimensioned to slidably engage and be enclosed by at least one vertical structural support.

### BRIEF DESCRIPTION OF THE DRAWINGS

For a fuller understanding of the nature of the present disclosure, reference should be had to the following detailed description taking in connection with the accompanying drawings in which:

FIG. 1 is a perspective view of one embodiment of the vertical insert member of the joint system.

FIG. 2 is an alternative perspective view of another embodiment of the vertical insert member (without an insert reinforcement member) of the joint system.

FIG. 3 is an exploded perspective view of an embodiment of the vertical insert member (without an insert reinforcement member) of the joint system.

FIG. 4 is an alternative exploded perspective view of an embodiment of the vertical insert member of the joint system.

FIG. 5 is an alternative exploded perspective view of another embodiment of the vertical insert member of the joint system.

FIG. 6 is an alternative exploded perspective view of another embodiment of the vertical insert member (specifically showing the insert reinforcement member) of the joint system.

FIG. 7 is a partially exploded perspective view of an embodiment of multiple vertical inserts and structural supports of the joint system.

FIG. 8 is an assembled perspective view of an embodiment of multiple vertical inserts and structural supports of the joint system.

FIG. 9 is a perspective view of the embodiment of the joint system, as shown in FIG. 8, in use on a piece of furniture.

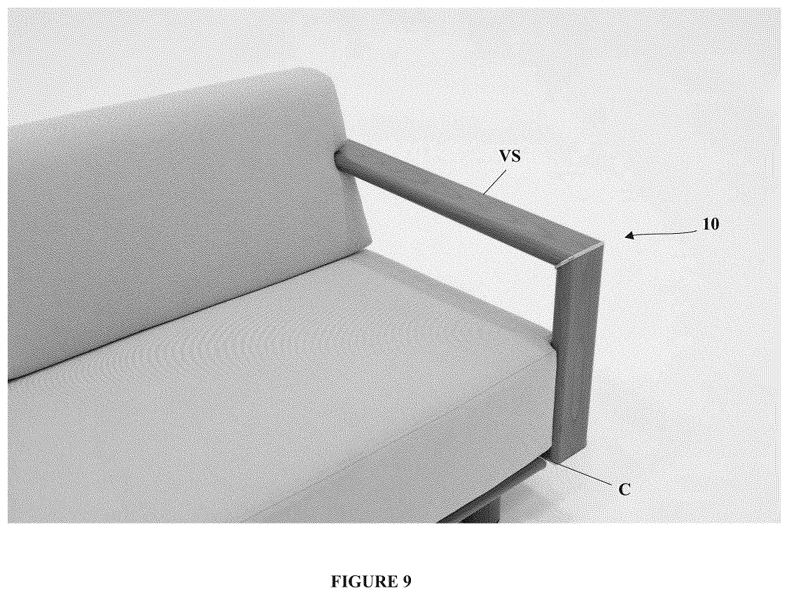

FIG. 10 is a perspective view of one embodiment of the flat insert member of the joint system.

FIG. 11 is an alternative perspective view of the embodiment of the flat insert member (as shown in FIG. 10) of the joint system.

FIG. 12 is an exploded perspective view of another embodiment of the flat insert member (specifically showing the insert reinforcement member) of the joint system.

FIG. 13 is an assembled perspective view of the embodiment of the flat insert member (as shown in FIG. 12 and specifically showing the insert reinforcement member) of the joint system.

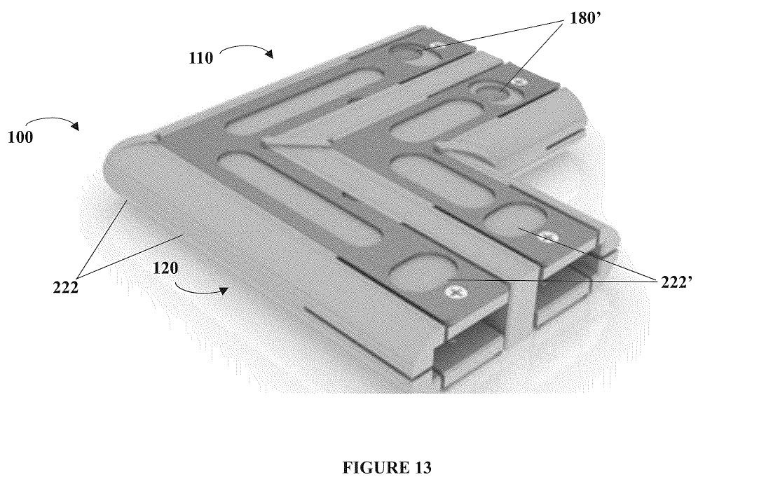

FIG. 14 is an exploded perspective view of another embodiment of the flat insert member of the joint system.

FIG. 15 is an exploded perspective view of another embodiment of the flat insert member of the joint system.

FIG. 16 is a partially exploded perspective view of an embodiment of multiple flat inserts and structural supports of the joint system.

FIG. 17 is an assembled perspective view of an embodiment of multiple flat inserts and structural supports of the joint system.

FIG. 18 is a perspective view of the embodiment of the joint system, as shown FIG. 17, in use on a piece of furniture.

FIG. 19 is a perspective view of an assembled piece of furniture that uses the joint system.

FIG. 20 is a perspective view of multiple assembled pieces of furniture that use the joint system.

Like reference numerals refer to like parts throughout the several views of the drawings.

### DETAILED DESCRIPTION OF THE INVENTION

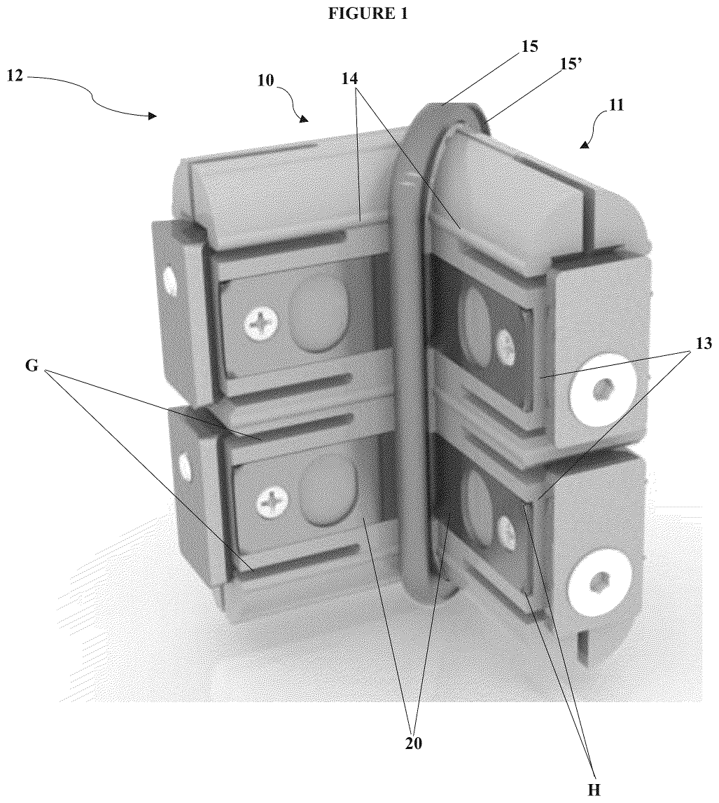

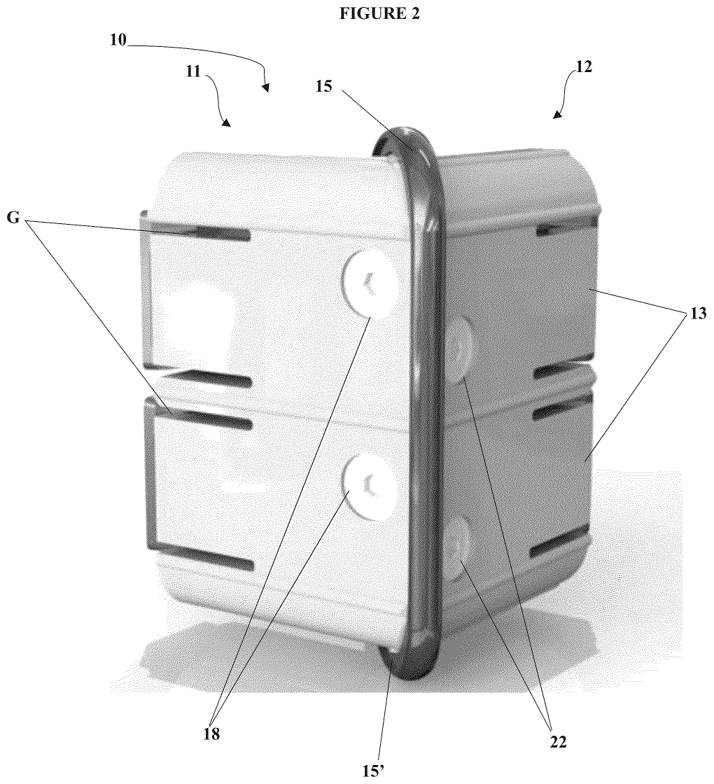

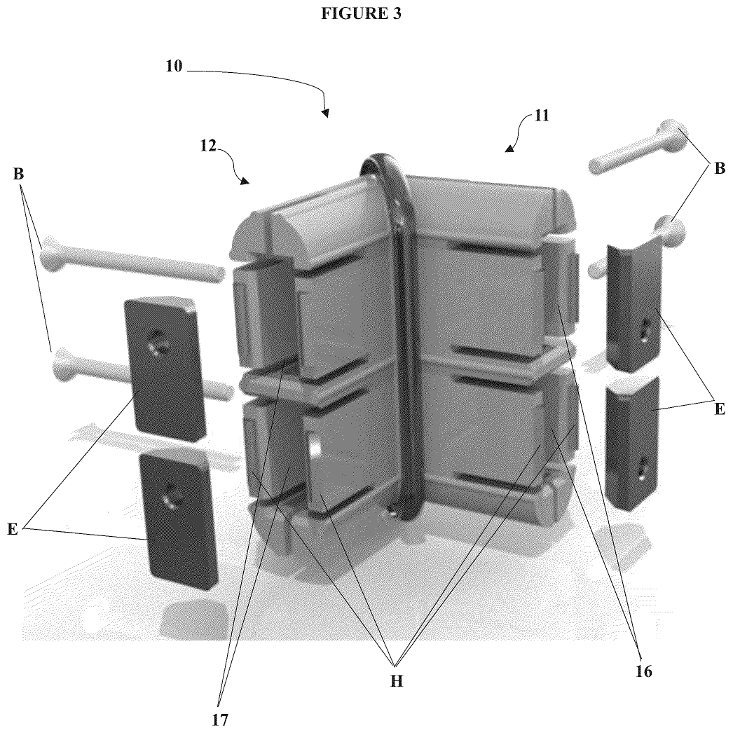

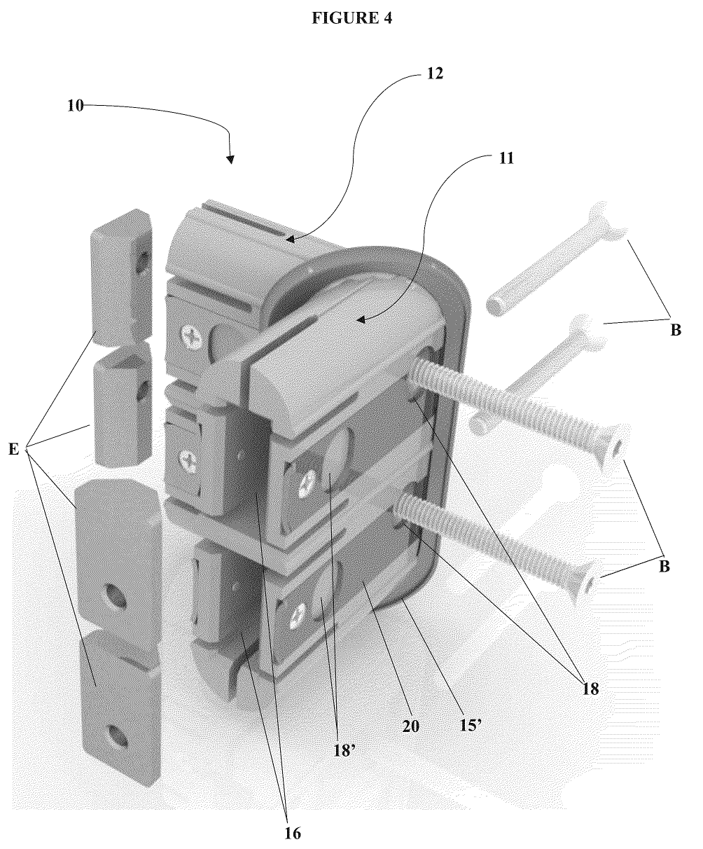

Turning now descriptively to the figures, FIG. 1 shows a vertical insert member 10, which comprises a first arm 11, a second arm 12, at least one expansion member 13 (which can exist on both the first arm 11 and second arm 12), at least one groove G (which can also exist on both the first arm 11 and second arm 12 and form gaps between the expansion members 13), at least one raised friction tab 14 (which can also exist on both the first arm 11 and second arm 12), at least one decorative element 15 (which can traverse the entire circumference of the seam/bend of the vertical insert member 10), a decorative element structural support receiver 15′, at least one hook structure H (which can exist on both first arm 11 and second arm 12 or on an insert reinforcement member 20), at least one channel of the first arm 16 (as is shown in at least FIG. 3), at least one channel for the second arm 17 (as is shown in at least FIG. 3), and at least one track for the insert reinforcement member 20″ (as is shown in at least FIG. 4, which inherently includes a receptacle or other structure for allowing the insert reinforcement member 20 to affix/attach to the vertical insert member 10). Also, as will be subsequently depicted in other FIGs and described, the vertical insert member 10 may allow for at least one expander E, to be inserted into at least one channel of the first arm 16 and/or at least one channel of the second arm 17. Further, the vertical insert member 10 may comprise at least one first arm locking receptacle 18 and/or at least one alternative first arm locking receptacle 18′ (as depicted in FIGS. 2, 3, 4). In addition, the vertical insert member 10 may comprise at least one second arm locking receptacle 22 and/or at least one alternative second arm locking receptacle 22′ (as depicted in FIG. 2).

The vertical insert member 10 need not comprise the decorative element 15. Instead, and as will become apparent after the following, should the vertical insert member 10 not include the decorative element 15, the joint system will allow for furniture designs without decorative corners, but still maintaining a flush/seamless appearance through the use of measured support members S/VS that joint together at a location where the decorative element 15 would have been placed on the vertical insert member 10.

The vertical insert member 10 can be one of multiple vertical insert members 10 that, when used with structural supports (denoted in the FIGs as S, FS, and/or VS) and/or structural support members S′, can build portions of furniture, entire furniture pieces, and/or entire furniture sets (as will be depicted and described). In addition, the vertical insert member 10 can be made of metal (such as aluminum) that has been formed/shaped or extruded. Alternatively, the vertical insert member 10 can be a polymer.

As such, considering the vertical insert member's 10 first arm 11, the first arm 11 may comprise at least one expansion member 13 where at least one groove G can allow for the expansion of the expansion member 13 (and perform other functions when an expander E is rotated by a bolt B and applies a force from the interior of the at least one expansion member 13 (as will be subsequently described with reference to other FIGs)). One other function of the groove G, is that it may allow corresponding tabs (that are not depicted in the FIGs and that are distinct from the raised friction tabs 14) that may be located in the interior of a structural support S/VS to align with the groove(s) G so as to engage, guide, or otherwise allow a structural support S/VS to enclose and/or encompass the first arm 11.

In addition, the first arm 11 may also comprise at least one raised friction tab 14. When the first arm 11 is engaged, enclosed, and/or encompassed by a structural support S/VS, the at least one raised friction tab 14 may require the force to disengage or otherwise remove a structural support S/VS from the first arm 11 to be greater than if the at least one raised friction tab 14 was not present. In effect, the at least one raised friction tab can exert a force on the interior of a structural support S/VS to require a greater force application to disengage or otherwise remove a structural support S/VS from the first arm 11.

Further, the first arm 11 may have a coating applied to the exterior thereof to allow for the exterior's frictional coefficient to be increased (making the exterior of the first arm 11 grippier). Once again, this coating can contact the interior of a structural support S/VS to require a greater force application to disengage or otherwise remove a structural support S/VS from the first arm 11.

Also, the first arm 11 may be described as originating from the decorative element's structural support receiver 15′ and extending outwardly (in a direction distinct, such as at an angle of 5° to 355°, from the second arm 12). At the extremity of the first arm 11 (away from the decorative element's structural support receiver 15′) and either on the first arm's 11 expansion members 13 or on the insert reinforcement member 20, a hook structure H may be present. This hook structure H may, when the first arm 11 is enclosed and/or encompassed by a structural support S/VS, engage with a corresponding hook structure within the interior of the structural support S/VS (as in not depicted in the FIGs) so as to lock or engage the structural support S/VS to the first arm 11. Notably, the decorative element's structural support receiver 15′ can receive an extremity or end of a structural support S/VS so as to hide or conceal the extremity or end of a structural support S/VS underneath the decorative element 15. This feature allows for the structural support S/VS to disappear into and/or under the decorative element 15.

With brief reference to FIGS. 2, 4 and 5, the first arm 11 may have at least one locking receptacle 18 but may also have an alternative at least one locking receptacle 18′ in addition to the at least one locking receptacle 18. This at least one locking receptacle 18 and/or alternative at least one locking receptacle 18′ may be used in conjunction with a bolt B, expander E, and the expansion members 13 among other elements to lock and/or engage a structural support S/VS to the first arm 11 (as will be described in more detail).

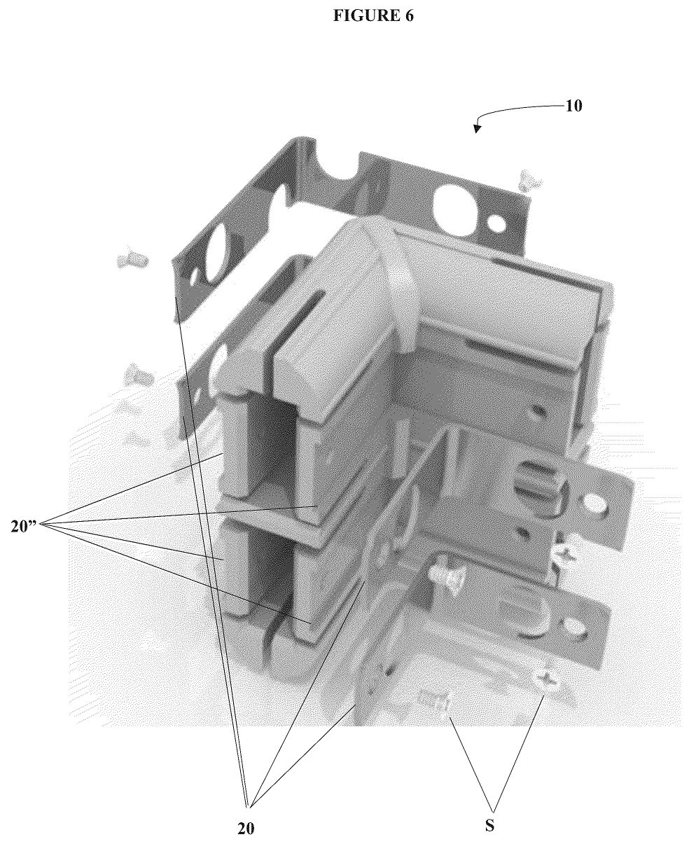

With continued reference to FIG. 1 and with reference to FIG. 6, the first arm 11 may also comprise a track for the insert reinforcement member 20″. As such, the insert reinforcement member 20 may be affixed to the first arm 11 (and the vertical insert member 10) so as to structurally reinforce the vertical insert member 10 and allow it to bear more load. As one may imagine, the application of the vertical insert member 10 is to allow for the creation of portions of furniture, entire furniture pieces, and/or entire furniture sets. As the vertical insert member 10 may be used in conjunction with multiple structural support S/VS (the structural supports able to be made of multiple materials and lengths), in some applications, that vertical insert member 10 may be to have a higher load bearing capacity (for example, when in use on a sofa versus a single seat chair). As such, the insert reinforcement member 20 may be affixed and placed in a track for the insert reinforcement member 20″. Notably, the vertical insert member 10 (and the first arm 11) may not require a track for the insert reinforcement member 20″. Either way, the insert reinforcement member 20 may be affixed or otherwise connected to the vertical insert member 10 (and the first arm 11) via conventional attachment means, such as a screw S. In addition, and as is not depicted, the reinforcement member 20 may be pre-built into the structure of the vertical insert member 10 or may be within the interior of the vertical insert member 10. Further, should the vertical insert member 10 be formed of a polymer, the polymer may have metal incorporated within the polymer so as to structurally reinforce the vertical insert member 10.

As such, considering the vertical insert member's 10 second arm 12, the second arm 12 may comprise at least one expansion member 13 where at least one groove G can allow for the expansion of the expansion member 13 (and perform other functions when an expander E is rotated by a bolt B and applies a force from the interior of the at least one expansion member 13 (as will be subsequently described with reference to other FIGs)). One other function of the groove G, is that it may allow corresponding tabs (that are not depicted in the FIGs and that are distinct from the raised friction tabs 14) that may be located in the interior of a structural support S/VS to align with the groove(s) G so as to engage, guide, or otherwise allow a structural support S/VS to enclose and/or encompass the second arm 12.

In addition, the second arm 12 may also comprise at least one raised friction tab 14. When the second arm 12 is engaged, enclosed, and/or encompassed by a structural support S/VS, the at least one raised friction tab 14 may require the force to disengaged or otherwise remove a structural support S/VS from the second arm 12 to be greater than if the at least one raised friction tab 14 was not present. In effect, the at least one raised friction tab can exert a force on the interior of a structural support S/VS to require a greater force application to disengage or otherwise remove a structural support S/VS from the second arm 12.

Further, the second arm 12 may have a coating applied to the exterior thereof to allow for the exterior's frictional coefficient to be increased (making the exterior of the second arm 12 grippier). Once again, this coating can contact the interior of a structural support S/VS to require a greater force application to disengage or otherwise remove a structural support S/VS from the second arm 12.

Also, the second arm 12 may be described as originating from the decorative element's structural support receiver 15′ and extending outwardly (in a direction distinct, such as at an angle of 5° to 355°, from the first arm 11). At the extremity of the second arm 12 (away from the decorative element's structural support receiver 15′) and either on the second arm's 12 expansion members 13 or on the insert reinforcement member 20, a hook structure H may be present. This hook structure H may, when the second arm 12 is enclosed and/or encompassed by a structural support S/VS, engage with a corresponding hook structure within the interior of the structural support S/VS (as is not depicted in the FIGs) so as to lock or engage the structural support S/VS to the second arm 12. Notably, the decorative element's structural support receiver 15′ can receive an extremity or end of a structural support S/VS so as to hide or conceal the extremity or end of a structural support S/VS underneath the decorative element 15. This feature allows for the structural support S/VS to disappear into and/or under the decorative element 15.

With brief reference to FIG. 2, the second arm 12 may have at least one locking receptacle 22, but may also have an alternative at least one locking receptacle 22′ in addition to the at least one locking receptacle 22. This at least one locking receptacle 22 and/or alternative at least one locking receptacle 22′ may be used in conjunction with a bolt B, expander E, and the expansion members 13 among other elements to lock and/or engage a structural support S/VS to the second arm 12 (as will be described in more detail).

With continued reference to FIG. 1 and with reference to FIG. 6, the second arm 12 may also comprise a track for the insert reinforcement member 20″. As such, the insert reinforcement member 20 may be affixed to the second arm 12 (and the vertical insert member 10) so as to structurally reinforce the vertical insert member 10 and allow it to bear more load. As one may imagine, the application of the vertical insert member 10 is to allow for the creation of portions of furniture, entire furniture pieces, and/or entire furniture sets. As the vertical insert member 10 may be used in conjunction with multiple structural support S/VS (the structural supports able to be made of multiple materials and lengths), in some applications, that vertical insert member 10 may be to have a higher load bearing capacity (for example, when in use on a sofa versus a single seat chair). As such, the insert reinforcement member 20 may be affixed and placed in a track for the insert reinforcement member 20″. Notably, the vertical insert member 10 (and the second arm 12) may not require a track for the insert reinforcement member 20″. Either way, the insert reinforcement member 20 may be affixed or otherwise connected to the vertical insert member 10 (and the second arm 12) via conventional attachment means, such as a screw S. As may now be apparent, the track for the insert reinforcement member 20″ may exist on either or both the first arm 11 and second arm 12 so as to receive an insert reinforcement member 20.

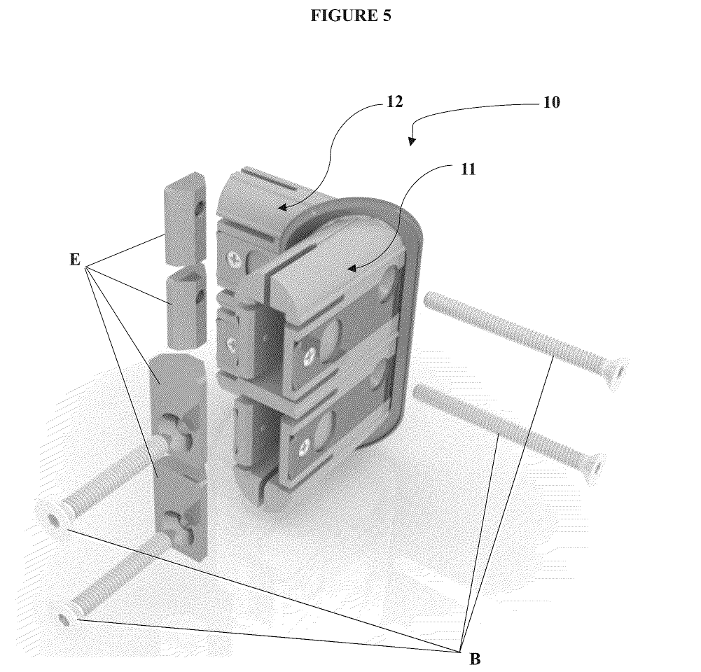

With reference now to FIGS. 1, 3, 4, and 5, it may be noted that the first arm 11 may have at least one expander E inserted into at least one channel of the first arm 16. As such, a bolt B may traverse at least one first arm locking receptacle 18, alternative at least one locking receptacle 18′, at least one second arm locking receptacle 22, and/or alternate at least one locking receptacle 22′ and enter the expander E. As the bolt B is rotated via a tool or other means, the expander E may also rotate within the at least one channel of the first arm 16. When the rotation of the expander E occurs, the expander E may apply a force against the expansion members 13 of the first arm 11, causing the first arm's 11 expansion members 13 to expand outwardly from the first arm's at least one channel 16. With this in mind, and with reference to FIGS. 2, 3, and 4, if a bolt B is inserted into the at least one of the second arm locking receptacles 22 or alternative second arm locking receptacles 22′ (although not imaged, but as can be imagined with reference to the alternative first arm locking receptacles 18′), then the bolt B traverses the first arm's channel 16 and into the expander E which is in the first arm's channel 16, then the bolt B is rotated, the expansion members 13 of the first arm 11 expand. In a separate embodiment, and with reference to FIG. 5, the bolt B may enter into the expander E, then traverse through the first arm's channel 16, then the bolt B may partially traverse through the second arm's locking receptacle 22 to accomplish the expansion of the first arm's 11 expansion members 13. In yet another embodiment, a bolt B may traverse the alternative first arm locking receptacle 18′ and traverse through the expander E. In such an embodiment, the expander E may be at a different orientation than as is depicted in FIG. 5 so as to allow the expander E to receive the bolt B. The bolt B may continue to apply a force to at least one expansion member 13 of the first arm 11 to cause at least one expansion member 13 of the first arm 11 to expand.

With continued reference now to FIGS. 1, 3, 4, and 5, and considering the above, it may be noted that the second arm 12 may have at least one expander E inserted into at least one channel of the second arm 17. As such, a bolt B may traverse at least one first arm locking receptacle 18, alternative at least one locking receptacle 18′, at least one second arm locking receptacle 22, and/or alternate at least one locking receptacle 22′ and enter the expander E. As the bolt B is rotated via a tool or other means, the expander E may also rotate within the at least one channel of the second arm 17. When the rotation of the expander E occurs, the expander E may apply a force against the expansion members 13 of the second arm 12, causing the second arm's 12 expansion members 13 to expand outwardly from the second arm's at least one channel 17. With this in mind, and with reference to FIGS. 2, 3, and 4, if a bolt B is inserted into the at least one of the first arm locking receptacles 18 (or alternative second arm locking receptacles 18′), then the bolt B traverses the second arm's channel 17 and into the expander E which is in the second arm's channel 17, then the bolt B is rotated, the expansion members 13 of the second arm 12 expand. In a separate embodiment, and without reference to a FIG, the bolt B may enter the expander E, then traverse through the second arm's channel 17, then the bolt B may partially traverse through the first arm's locking receptacle 18 to accomplish the expansion of the second arm's 12 expansion members 13. In yet another embodiment, a bolt B may traverse the alternative second arm locking receptacle 22′ (which is not depicted in the FIGSs, but can be imagined with reference to the alternative first arm locking receptacles 18′) and traverse through the expander E. In such an embodiment, the expander E may be at a different orientation than as was mentioned in the embodiment described immediately prior, so as to allow the expander E to receive the bolt B. The bolt B may continue to apply a force to at least one expansion member 13 of the second arm 12 to cause at least one expansion member 13 of the second arm 12 to expand.

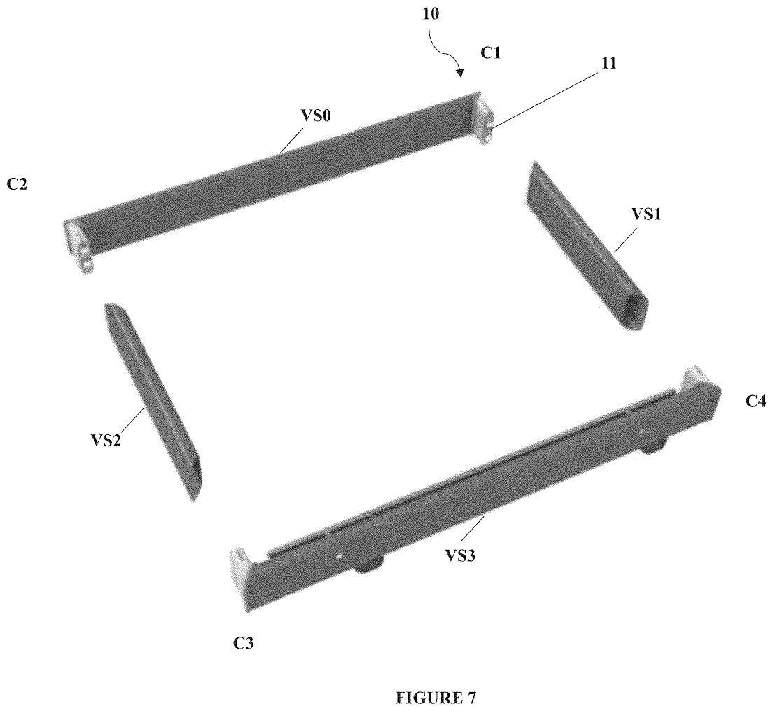

As such, it may be more clear that structural supports S/VS slidably engage over the arms (11/12) of the vertical insert member 10, where the arms (11/12), through the use of expansion members 13 and other elements (14, G, H) engage the structural supports S/VS so as to lock the structural supports S/VS to the arms, yet provide a visual effect that allows for the structural support S/VS to disappear into and/or under the decorative element 15. Moreover, it may be clearer that structural supports S/VS can be arranged in a specific fashion while being affixed/engaged to the arms (11/12) of the vertical insert member 10 so as to allow for a visual effect where an ordinary observer may not immediately determine how a structure/piece of furniture is formed. As such, with reference now to FIG. 7, it can be noted that at corner 1 (C1), a vertical insert member 10 has its second arm 12 inserted into structural support VS0 with its first arm 11 not yet engaged with a structural support VS1. That said, the second arm 12 could have been engaged with structural support VS0 by an expander E existing within a channel of the second arm 17. A bolt B could have been inserted into the first arm's locking receptacle 18 and rotated the expander E, causing the structural support VS0 to engage and lock with the second arm 12. Considering the above, the structural support VS1 can be slid over 11, thereafter at least one bolt B may be inserted into the first arm's 11 channel 16 (with an expander E therein). A tool may be used to extend through the support structure VS1 so as to rotate the bolt B and have the first arm's 11 expansion members 13 secure and engage the support structure VS1 to the first arm 11. As one can imagine, a highly similar process as described above can apply at corner 2 C2. In effect, should this occur, it would appear that no visible hardware was used to lock VS0, VS1, and VS2 into a structure, yet the decorative elements 15 would be visible. As such, and with continued reference to FIG. 7, assuming VS3 was—not—connected to the vertical insert member at corner 3 C3, and if the VS0, VS1, VS2 structure had been completed in accordance with the above, the vertical insert member's 10 first arm 11, at corner 3 C3, could be inserted into the structural support VS2 and engaged thereto through the insertion of a bolt at the second arm's locking receptacle 22. Thereafter, structural support VS3 could be slid over and engaged to the second arm 12 of the vertical insert member 10 at corner 3 C3. A bolt B could be placed through VS3, traversing into an expander E within the vertical insert member's 10 second arm's channel 17. Thereafter, the bolt could be rotated, causing the second arm's 12 expansion members 13 to engage the structural support VS3. Thereafter, the vertical insert member 10 at corner 4, C4 could have its first arm 11 inserted into structural support VS3, with bolts traversing through the second arm's 12 locking receptacles 22, causing the first arm 11 of the vertical insert member 10 at corner 4 C4 to lock into place with structural support VS3. After that, the structural support VS1 could slide over the vertical insert member's 10 second arm 12 at corner 4 C4 where a bolt B could traverse through—both—the structural support VS1 and an alternative locking receptacle 22′ of the second arm 12 (causing the second arm 12 to become locked with the structural support VS1 via the aforementioned elements that allow for such locking).

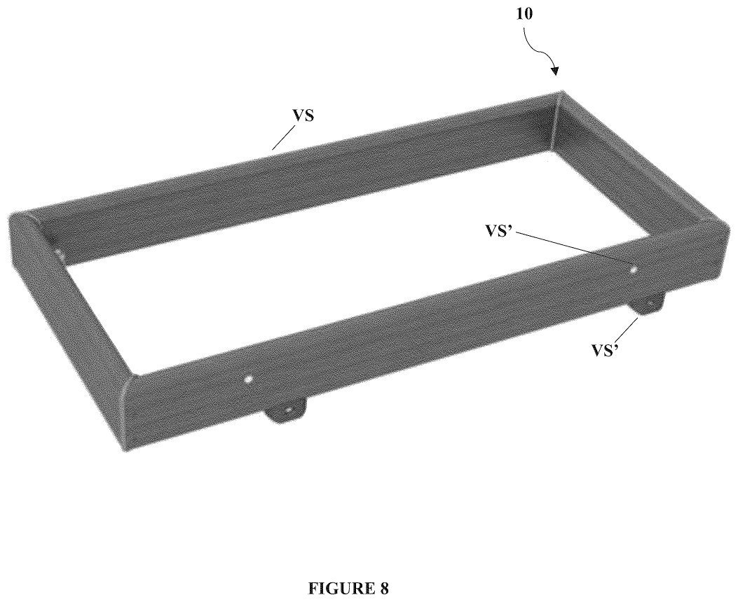

As such, the structure as depicted in FIG. 8 could be created. Considering the above, the system allows for only one visual cue as to how the structure as depicted in FIG. 8 was created, namely, how one bolt B can traverse through—both—the structural support VS1 and an alternative locking receptacle 22′ of the second arm 12. As such, this allows for an aesthetically pleasing structure for furniture to be created where an ordinary observer may not immediately determine how a structure/piece of furniture is formed/assembled. With continued reference to FIG. 8, it should be noted that a structural support S/VS may comprise attachment points S′/VS′ that allow for structural supports to connect with other structural supports S/VS/FS or structures S′. As just one example, structures S′ may be legs for furniture or connectors C that allow for structural supports S/VS/FS to connect to one another. In addition, the present disclosure expressly allows for structural supports to be considered or named as structural support members. The present disclosure also allows for structural support members that connect to vertical insert members 10 to be described as vertical structural supports or vertical structural support members VS. Also, the support members S/VS/FS may be made of metal or a polymer. In addition, the support members S/VS/FS may be of varying lengths to accommodate and provide for different styles of furniture or designs. Further, the support members S/VS/FS may have an indicia applied thereto to allow the support members S/VS/FS to appear as natural wood or another textured material.

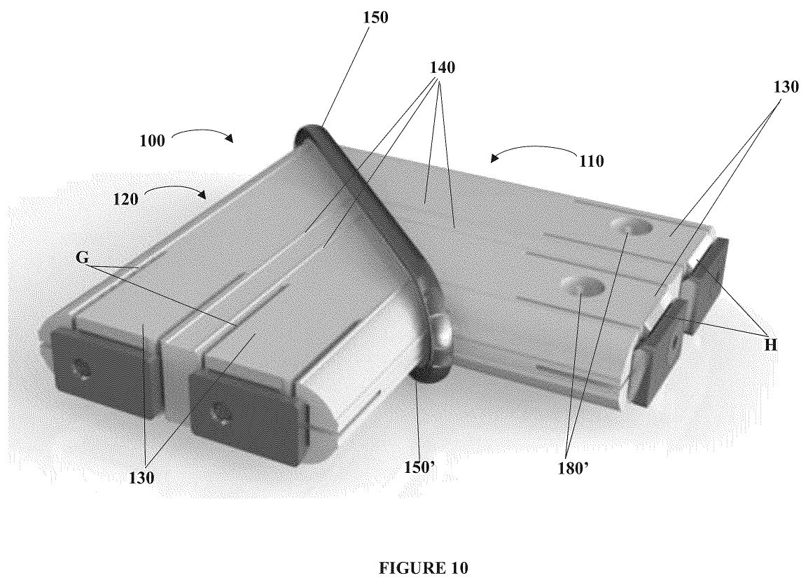

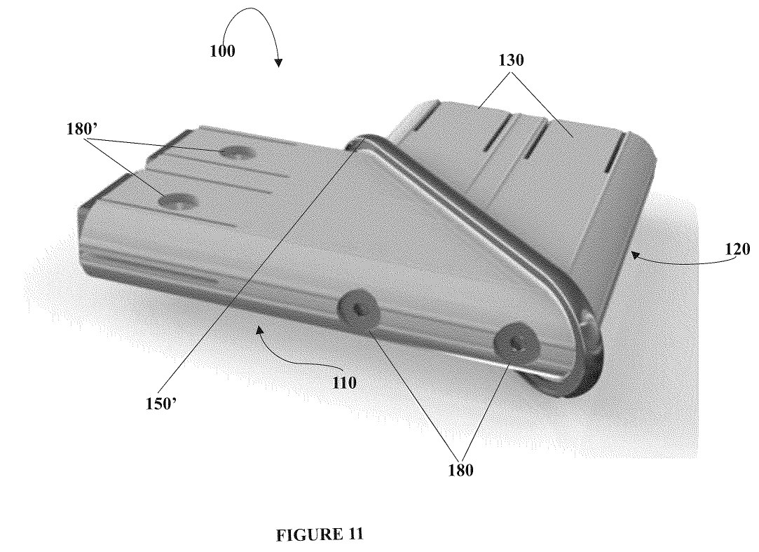

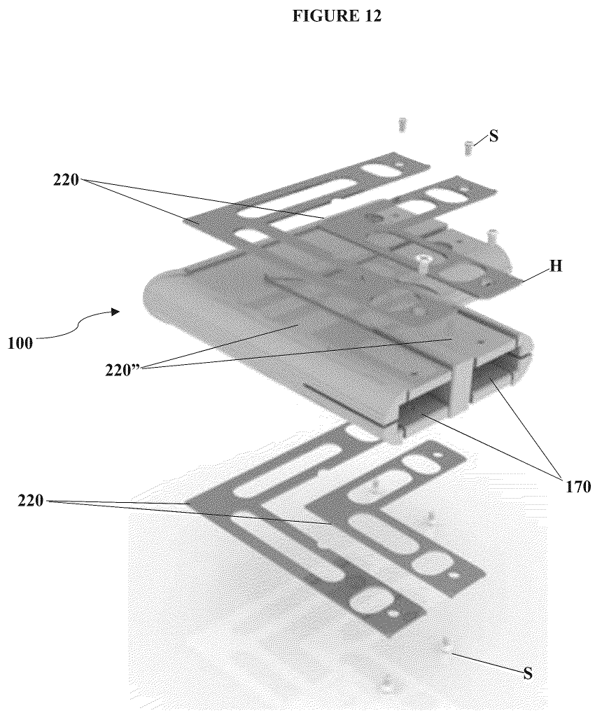

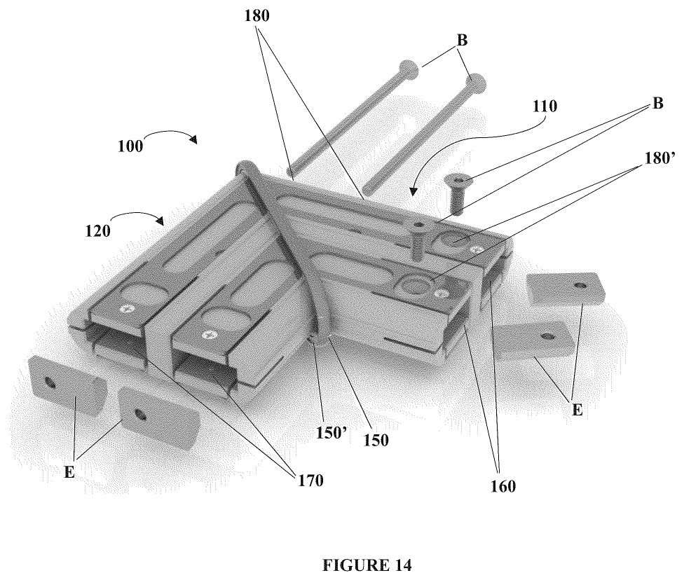

With reference now to FIG. 10, the FIG shows a flat insert member 100, which comprises a first arm 110, a second arm 120, at least one expansion member 130 (which can exist on both the first arm 110 and second arm 120), at least one groove G (which can also exist on both the first arm 110 and second arm 120 and form gaps between the expansion members 130), at least one raised friction tab 140 (which can also exist on both the first arm 110 and second arm 120), at least one decorative element 150 (which can traverse the entire circumference of the seam/bend of the flat insert member 100), a decorative element structural support receiver 150′, at least one hook structure H (which can exist on both first arm 110 and second arm 120 or on an insert reinforcement member 220), at least one channel of the first arm 160 (as is shown in at least FIG. 14), at least one channel for the second arm 170 (as is shown in at least FIG. 14), and at least one track for the insert reinforcement member 220″ (as is shown in at least FIG. 12, which inherently includes a receptacle or other structure for allowing the insert reinforcement member 220 to affix/attach to the flat insert member 100). Also, as will be subsequently depicted in other FIGs and described, the flat insert member 100 may allow for at least one expander E, to be inserted into at least one channel of the first arm 160 and/or at least one channel of the second arm 170. Further, the flat insert member 100 may comprise at least one first arm locking receptacle 180 and/or at least one alternative first arm locking receptacle 180′ (as depicted in at least FIG. 11). In addition, the flat insert member 100 may comprise at least one second arm locking receptacle 220 and/or at least one alternative second arm locking receptacle 220′ (as is not depicted, but as may be inferred based on the above and the following paragraph).

The flat insert member 100 need not comprise the decorative element 150. Instead, and as will become apparent after the following, should the flat insert member 100 not include the decorative element 150, the joint system will allow for furniture designs without decorative corners, but still maintaining a flush/seamless appearance through the use of measured support members S/FS that joint together at a location where the decorative element 150 would have been placed on the flat insert member 100.

As may be noted, many features and elements of the flat insert member 100 are similar to the vertical insert member 10. However, the flat insert member 100 may be distinct in form and shape so as to allow for easily building flat structures for furniture whereas the vertical insert member 10 may be for easily building vertical structures for furniture. With this in mind, it should be noted that both insert members 10/100 function in highly similar ways and should be considered as equals but for their shape and dimensioning. That said, the following still exemplifies the use of the flat insert member 100 and how it may be combined with the use of the aforementioned vertical insert member 10. However, this should only be considered for exemplary purposes.

That said, flat insert member 100 can be one of multiple flat insert member 100 that, when used with structural supports (denoted in the FIGs as S, FS, and/or VS) and/or structures S′, can build portions of furniture, entire furniture pieces, and/or entire furniture sets (as will be depicted and described). In addition, the flat insert member 100 can be made of metal (such as aluminum) that has been formed/shaped or extruded. Alternatively, the flat insert member 100 can be a polymer.

As such, considering the flat insert member's 100 first arm 110, the first arm 110 may comprise at least one expansion member 130 where at least one groove G can allow for the expansion of the expansion member 130 (and perform other functions when an expander E is rotated by a bolt B and applies a force from the interior of the at least one expansion member 13 (as will be subsequently described with reference to other FIGs)). One other function of the groove G, is that it may allow corresponding tabs (that are not depicted in the FIGs and that are distinct from the raised friction tabs 140) that may be located in the interior of a structural support S/FS to align with the groove(s) G so as to engage, guide, or otherwise allow a structural support S/FS to enclose and/or encompass the first arm 110.

In addition, the first arm 110 may also comprise at least one raised friction tab 140. When the first arm 110 is engaged, enclosed, and/or encompassed by a structural support S/FS, the at least one raised friction tab 140 may require the force to disengaged or otherwise remove a structural support S/FS from the first arm 110 to be greater than if the at least one raised friction tab 140 was not present. In effect, the at least one raised friction tab can exert a force on the interior of a structural support S/FS to require a greater force application to disengage or otherwise remove a structural support S/FS from the first arm 110.

Further, the first arm 110 may have a coating applied to the exterior thereof to allow for the exterior's frictional coefficient to be increased (making the exterior of the first arm 110 grippier). Once again, this coating can contact the interior of a structural support S/FS to require a greater force application to disengage or otherwise remove a structural support S/FS from the first arm 110.

Also, the first arm 110 may be described as originating from the decorative element's structural support receiver 150′ and extending outwardly (in a direction distinct, such as at an angle of 5° to 355°, from the second arm 120). At the extremity of the first arm 110 (away from the decorative element's structural support receiver 150′) and either on the first arm's 110 expansion members 130 or on the insert reinforcement member 220, a hook structure H may be present. This hook structure H may, when the first arm 101 is enclosed and/or encompassed by a structural support S/FS, engage with a corresponding hook structure within the interior of the structural support S/FS (as is not depicted in the FIGs) so as to lock or engage the structural support S/FS to the first arm 110. Notably, the decorative element's structural support receiver 150′ can receive an extremity or end of a structural support S/FS so as to hide or conceal the extremity or end of a structural support S/FS underneath the decorative element 150. This feature allows for the structural support S/FS to disappear into and/or under the decorative element 150.

With brief reference to at least FIG. 14, the first arm 110 may have at least one locking receptacle 180 but may also have an alternative at least one locking receptacle 180′ in addition to the at least one locking receptacle 180. This at least one locking receptacle 180 and/or alternative at least one locking receptacle 180′ may be used in conjunction with a bolt B, expander E, and the expansion members 130 among other elements to lock and/or engage a structural support S/FS to the first arm 110 (as will be described in more detail).

With continued reference to FIG. 10 and with reference to FIG. 12, the first arm 110 may also comprise a track for the insert reinforcement member 220″. As such, the insert reinforcement member 220 may be affixed to the first arm 110 (and the flat insert member 100) so as to structurally reinforce the flat insert member 100 and allow it to bear more load. As one may imagine, the application of the flat insert member 100 is to allow for the creation of portions of furniture, entire furniture pieces, and/or entire furniture sets. As the flat insert member 100 may be used in conjunction with multiple structural support S/FS (the structural supports able to be made of multiple materials and lengths), in some applications, that flat insert member 100 may be to have a higher load bearing capacity (for example, when in use on a sofa versus a single seat chair). As such, the insert reinforcement member 220 may be affixed and placed in a track for the insert reinforcement member 220″. Notably, the flat insert member 100 (and the first arm 110) may not require a track for the insert reinforcement member 220″. Either way, the insert reinforcement member 220 may be affixed or otherwise connected to the flat insert member 100 (and the first arm 110) via conventional attachment means, such as a screw S. In addition, and as is not depicted, the reinforcement member 220 may be pre-built into the structure of the flat insert member 100 or may be within the interior of the flat insert member 100. Further, should the flat insert member 100 be formed of a polymer, the polymer may have metal incorporated within the polymer so as to structurally reinforce the flat insert member 100.

As such, considering the flat insert member's 100 second arm 120, the second arm 120 may comprise at least one expansion member 130 where at least one groove G can allow for the expansion of the expansion member 130 (and perform other functions when an expander E is rotated by a bolt B and applies a force from the interior of the at least one expansion member 130 (as will be subsequently described with reference to other FIGs)). One other function of the groove G, is that it may allow corresponding tabs (that are not depicted in the FIGs and that are distinct from the raised friction tabs 140) that may be located in the interior of a structural support S/FS to align with the groove(s) G so as to engage, guide, or otherwise allow a structural support S/FS to enclose and/or encompass the second arm 120.

In addition, the second arm 120 may also comprise at least one raised friction tab 140. When the second arm 120 is engaged, enclosed, and/or encompassed by a structural support S/FS, the at least one raised friction tab 140 may require the force to disengaged or otherwise remove a structural support S/FS from the second arm 120 to be greater than if the at least one raised friction tab 140 was not present. In effect, the at least one raised friction tab 140 can exert a force on the interior of a structural support S/FS to require a greater force application to disengage or otherwise remove a structural support S/FS from the second arm 120.

Further, the second arm 120 may have a coating applied to the exterior thereof to allow for the exterior's frictional coefficient to be increased (making the exterior of the second arm 120 grippier). Once again, this coating can contact the interior of a structural support S/FS to require a greater force application to disengage or otherwise remove a structural support S/FS from the second arm 120.

Also, the second arm 120 may be described as originating from the decorative element's structural support receiver 150′ and extending outwardly (in a direction distinct, such as at an angle of 5° to 355°, from the first arm 110). At the extremity of the second arm 120 (away from the decorative element's structural support receiver 150′) and either on the second arm's 120 expansion members 130 or on the insert reinforcement member 220, a hook structure H may be present. This hook structure H may, when the second arm 120 is enclosed and/or encompassed by a structural support S/FS, engage with a corresponding hook structure within the interior of the structural support S/FS (as is not depicted in the FIGs) so as to lock or engage the structural support S/FS to the second arm 120. Notably, the decorative element's structural support receiver 150′ can receive an extremity or end of a structural support S/FS so as to hide or conceal the extremity or end of a structural support S/FS underneath the decorative element 150. This feature allows for the structural support S/FS to disappear into and/or under the decorative element 150.

With brief reference to FIG. 14, the second arm 120 may have at least one locking receptacle 222 but may also have an alternative at least one locking receptacle 222′ in addition to the at least one locking receptacle 222. This at least one locking receptacle 222 and/or alternative at least one locking receptacle 222′ may be used in conjunction with a bolt B, expander E, and the expansion members 130 among other elements to lock and/or engage a structural support S/FS to the second arm 120 (as will be described in more detail).

With continued reference to FIG. 10 and with reference to FIG. 2, the second arm 120 may also comprise a track for the insert reinforcement member 220″. As such, the insert reinforcement member 220 may be affixed to the second arm 120 (and the flat insert member 100) so as to structurally reinforce the flat insert member 100 and allow it to bear more load. As one may imagine, the application of the flat insert member 100 is to allow for the creation of portions of furniture, entire furniture pieces, and/or entire furniture sets. As the flat insert member 100 may be used in conjunction with multiple structural support S/FS (the structural supports able to be made of multiple materials and lengths), in some applications, that flat insert member 100 may be to have a higher load bearing capacity (for example, when in use on a sofa versus a single seat chair). As such, the insert reinforcement member 220 may be affixed and placed in a track for the insert reinforcement member 220″. Notably, the flat insert member 100 (and the second arm 120) may not require a track for the insert reinforcement member 220″. Either way, the insert reinforcement member 220 may be affixed or otherwise connected to the flat insert member 100 (and the second arm 120) via conventional attachment means, such as a screw S. As may now be apparent, the track for the insert reinforcement member 220″ may exist on either or both the first arm 110 and second arm 120 so as to receive an insert reinforcement member 220.

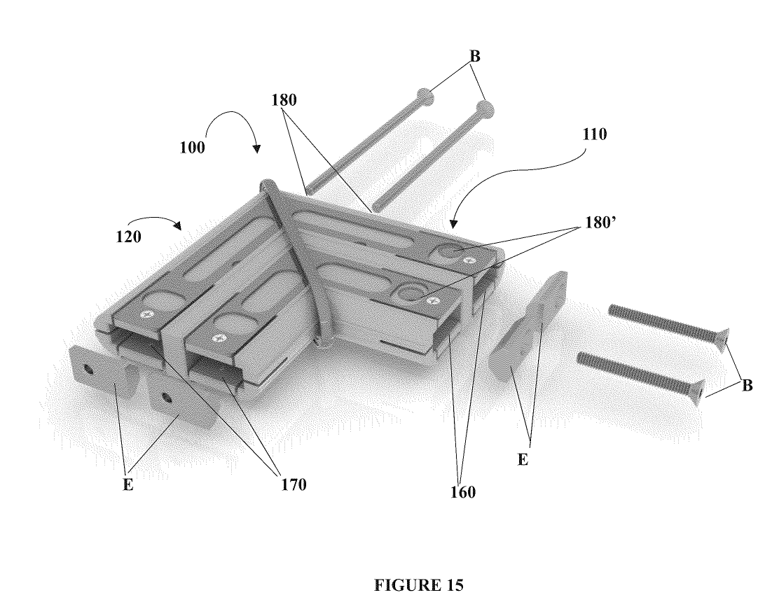

With reference now to FIGS. 10, 11, 14, and 15, it may be noted that the first arm 110 may have at least one expander E inserted into at least one channel of the first arm 160. As such, a bolt B may traverse at least one first arm locking receptacle 180, alternative at least one locking receptacle 180′, at least one second arm locking receptacle 222, and/or alternate at least one locking receptacle 222′ and enter the expander E. As the bolt B is rotated via a tool or other means, the expander E may also rotate within the at least one channel of the first arm 160. When the rotation of the expander E occurs, the expander E may apply a force against the expansion members 130 of the first arm 110, causing the first arm's 110 expansion members 130 to expand outwardly from the first arm's at least one channel 160. With this in mind, and with reference to FIGS. 14 and 15, if a bolt B is inserted into the at least one of the second arm locking receptacles 222 (or alternative second arm locking receptacles 222′ (although not imaged, but as can be imagined with reference to the alternative first arm locking receptacles 180′), then the bolt B traverses the first arm's channel 160 and into the expander E which is in the first arm's channel 160, then the bolt B is rotated, the expansion members 130 of the first arm 110 expand. In a separate embodiment, and with reference to FIG. 5, the bolt B may enter the expander E, then traverse through the first arm's channel 160, then the bolt B may partially traverse through the second arm's locking receptacle 222 to accomplish the expansion of the first arm's 110 expansion members 130. In yet another embodiment, a bolt B may traverse the alternative first arm locking receptacle 180′ and traverse through the expander E. In such an embodiment, the expander E may be at a different orientation as is depicted in FIG. 14 so as to allow the expander E to receive the bolt B. The bolt B may continue to apply a force to at least one expansion member 130 of the first arm 110 to cause at least one expansion member 130 of the first arm 110 to expand.

With continued reference now to the aforementioned FIGs and considering the above, it may be noted that the second arm 120 may have at least one expander E inserted into at least one channel of the second arm 170. As such, a bolt B may traverse at least one first arm locking receptacle 180, alternative at least one locking receptacle 180′, at least one second arm locking receptacle 222, and/or alternate at least one locking receptacle 222′ and enter the expander E. As the bolt B is rotated via a tool or other means, the expander E may also rotate within the at least one channel of the second arm 170. When the rotation of the expander E occurs, the expander E may apply a force against the expansion members 130 of the second arm 120, causing the second arm's 120 expansion members 130 to expand outwardly from the second arm's at least one channel 170. With this in mind, if a bolt B is inserted into the at least one of the first arm locking receptacles 180 (or alternative second arm locking receptacles 180′), then the bolt B traverses the second arm's channel 170 and into the expander E which is in the second arm's channel 170, then the bolt B is rotated, the expansion members 130 of the second arm 120 expand. In a separate embodiment, and without reference to a FIG, the bolt B may enter into the expander E, then traverse through the second arm's channel 170, then the bolt B may partially traverse through the first arm's locking receptacle 180 to accomplish the expansion of the second arm's 120 expansion members 130. In yet another embodiment, a bolt B may traverse the alternative second arm locking receptacle 222′ (which is not depicted in the FIGSs, but can be imagined with reference to the alternative first arm locking receptacles 180′) and traverse through the expander E. In such an embodiment, the expander E may be at a different orientation than as was mentioned in the embodiment described immediately prior, so as to allow the expander E to receive the bolt B. The bolt B may continue to apply a force to at least one expansion member 130 of the second arm 120 to cause at least one expansion member 130 of the second arm 120 to expand.

As such, it may be more clear that structural supports S/FS slidably engage over the arms (110/120) of the flat insert member 100, where the arms (110/120), through the use of expansion members 130 and other elements (140, G, H) engage the structural supports S/FS so as to lock the structural supports S/FS to the arms, yet provide a visual effect that allows for the structural support S/FS to disappear into and/or under the decorative element 150. Moreover, it may be clearer that structural supports S/FS can be arranged in a specific fashion while being affixed/engaged to the arms (110/120) of the flat insert member 100 so as to allow for a visual effect where an ordinary observer may not immediately determine how a structure/piece of furniture is formed.

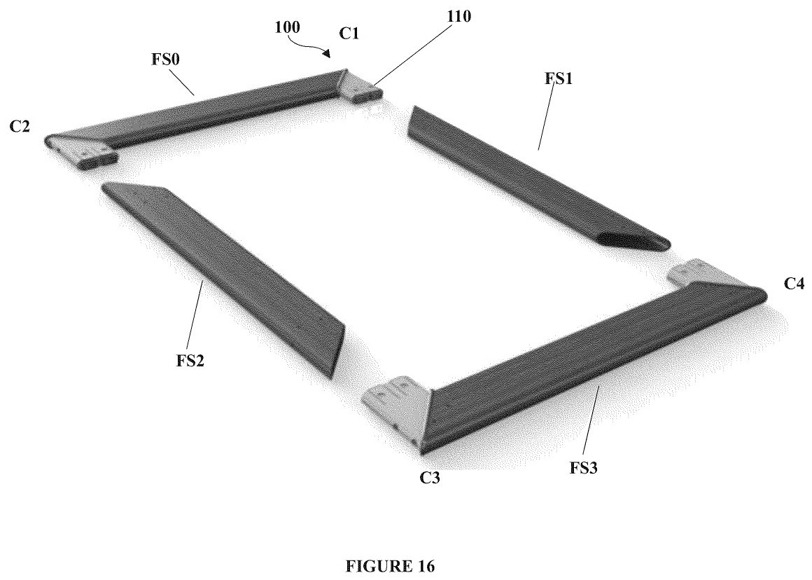

As such, with reference now to FIG. 16, it can be noted that at corner 1 (C1), a flat insert member 100 has its second arm 120 inserted into structural support FS0 with its first arm 110 not yet engaged with a structural support FS1. That said, the second arm 120 could have been engaged with structural support FS0 by an expander E existing within a channel of the second arm 170. A bolt B could have been inserted into the first arm's locking receptacle 180 and rotated the expander E, causing the structural support FS0 to engage and lock with the second arm 120. Considering the above, the structural support FS1 can be slid over 110, thereafter at least one bolt B may be inserted into the first arm's 110 channel 160 (with an expander E therein). A tool may be used to extend through the support structure FS1 so as to rotate the bolt B and have the first arm's 110 expansion members 130 secure and engage the support structure FS1 to the first arm 110. As one can imagine, a highly similar process as described above can apply at corner 2 C2. In effect, should this occur, it would appear that no visible hardware was used to lock FS0, FS1, and FS2 into a structure, yet the decorative elements 150 would be visible. As such, and with continued reference to FIG. 16, assuming FS3 was-not-connected to the flat insert member at corner 3 C3, and if the FS0, FS1, FS2 structure had been completed in accordance with the above, the flat insert member's 100 first arm 110, at corner 3 C3, could be inserted into the structural support FS2 and engaged thereto through the insertion of a bolt at the second arm's locking receptacle 222. Thereafter, structural support FS3 could be slid over and engaged to the second arm 120 of the flat insert member 100 10 at corner 3 C3. A bolt B could be placed through FS3, traversing into an expander E within the flat insert member's 100 second arm's channel 170. Thereafter, the bolt could be rotated, causing the second arm's 120 expansion members 130 to engage the structural support FS3. Thereafter, the flat insert member 100 at corner 4, C4 could have its first arm 110 inserted into structural support FS3, with a bolt B traversing through the second arm's 120 locking receptacles 222, causing the first arm 110 of the flat insert member 100 at corner 4 C4 to lock into place with structural support FS3. After that, the structural support FS1 could slide over the flat insert member's 100 second arm 120 at corner 4 C4 where a bolt B could traverse through—both—the structural support FS1 and an alternative locking receptacle 222′ of the second arm 120 (causing the second arm 120 to become locked with the structural support FS1 via the aforementioned elements that allow for such locking).

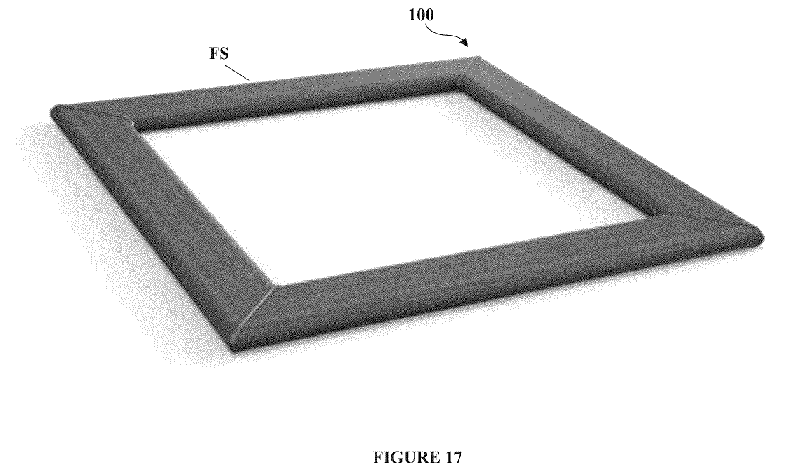

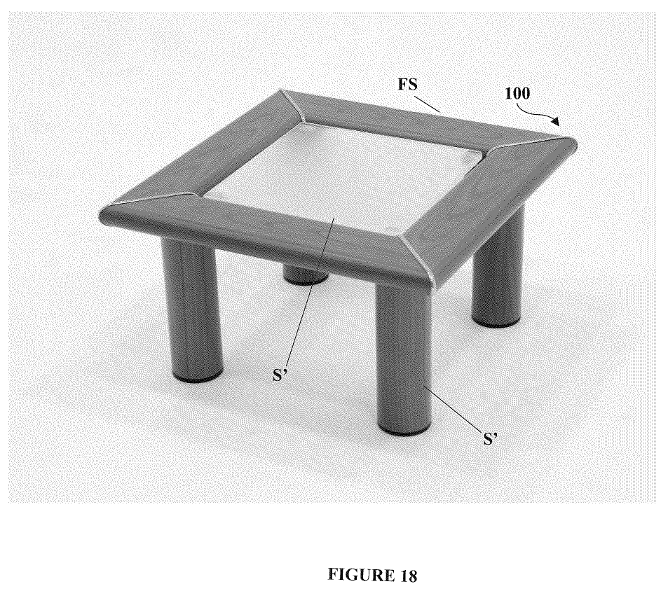

As such, the structure as depicted in FIG. 17 could be created. Considering the above, the system allows for only one visual cue as to how the structure as depicted in FIG. 17 was created, namely, how one bolt B can traverse through—both—the structural support FS1 and an alternative locking receptacle 222′ of the second arm 120. As such, this allows for an aesthetically pleasing structure for furniture to be created where an ordinary observer may not immediately determine how a structure/piece of furniture is formed/assembled. With continued reference to FIG. 17, it should be noted that a structural support S/FS may comprise attachment points S′/FS′ that allow for structural supports to connect with other structural supports S/VS/FS or structures S′. For example, with reference now to FIG. 18, the structure as depicted in FIG. 17 can be seen as having used a connector C (not depicted in the FIG) to allow for four structures S′ to create a table with the structure depicted in FIG. 17, as well as a structure S′ acting as a tabletop.

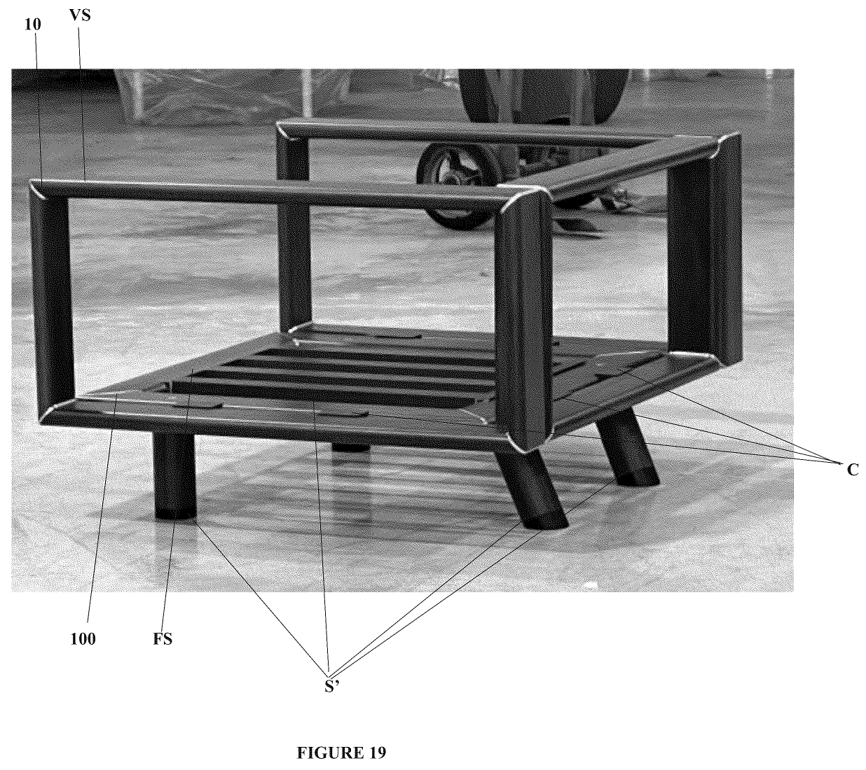

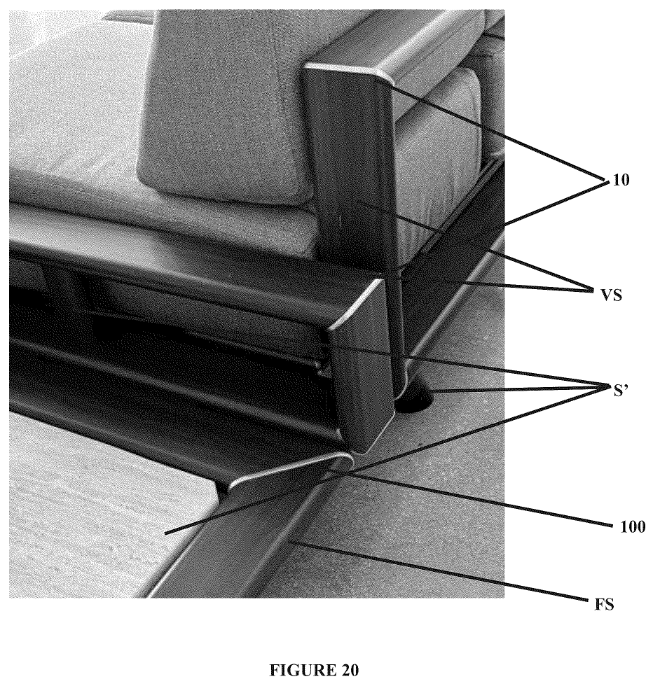

As previously mentioned, structural support S/FS may comprise attachment points S′/FS′ that allow for structural supports to connect with other structural supports S/VS/FS or structures S′. As such, with reference now to FIGS. 19-20. FIGS. 19-20 show some examples of furniture and designs that can be created with the instant system.

It is intended that all matters in the foregoing disclosure and shown in the accompanying drawings be interpreted as illustrative and not in a limiting sense.

What is claimed is:

1. A joint system comprising:
an insert member;
said insert member further comprising a first arm and a second arm;
said first arm comprising at least one channel having expansion members formed around said channel;
said first arm comprising at least two locking receptacles; and
said second arm comprising at least one channel having expansion members formed around said channel.

2. The joint system of claim 1 wherein said insert member is selected from the group consisting of a flat insert member and a vertical insert member.

3. The joint system of claim 1 wherein said first arm and said second arm each comprise at least one raised friction tab and are each coated with a substance to increase said first arm's and said second arm's frictional coefficient.

4. The joint system of claim 1 wherein said first arm's at least one channel is configured and dimensioned to receive an expander, and wherein said second arm's at least one channel is configured and dimensioned to receive an expander.

5. The joint system of claim 4 wherein at least one bolt is configured and dimensioned to pass through at least one locking receptacle of said first arm to be inserted into said expander within said first arm's at least one channel, and, when the at least one bolt is rotated, said expander within said first arm's at least one channel applies a force to said first arm's at least one channel, wherein said first arm's at least one channel's expansion members expand.

6. The joint system of claim 4 wherein at least one bolt is configured and dimensioned to pass through at least one locking receptacle of said first arm to be inserted into said expander within said second arm's at least one channel, and, when the at least one bolt is rotated, said expander within said second arm's at least one channel applies a force to said second arm's at least one channel, wherein said second arm's at least one channel's expansion members expand.

7. The joint system of claim 1 wherein at least one of said first arm's expansion members comprise at least one hook structure and wherein at least one of said second arm's expansion members comprise at least one hook structure.

8. The joint system of claim 7 further comprising at least two structural supports wherein one of said structural supports is configured and dimensioned to slidably engage and enclose said first arm and wherein another of said structural supports is configured and dimensioned to slidably engage and enclose said second arm.

9. The joint system of claim 8 wherein said at least two structural supports each comprise at least one hook structure each that correspond to said at least one hook structure of said expansion members of said first arm and at least one hook structure of said expansion members of said second arm.

10. The joint system of claim 9 wherein said at least two structural supports are configured and dimensioned to engage and enclose arms of at least two other joint systems.

11. The joint system of claim 10 wherein said at least two structural supports comprise a wood grain indicia applied to the exterior of said at least one structural supports.

12. A joint system comprising:
an insert member;
an insert reinforcement member configured and dimensioned to removably affix to and structurally reinforce said insert member;
said insert member comprising a decorative element;
said insert member further comprising a first arm and a second arm;
said first arm comprising at least one channel having expansion members formed around said channel;
said first arm comprising least one locking receptacle;
said second arm comprising at least one channel having expansion members formed around said channel; and
said second arm comprising at least one locking receptacle.

13. The joint system of claim 12 wherein said insert member is selected from the group consisting of a flat insert member and a vertical insert member.

14. The joint system of claim 12 wherein said first arm's at least one channel is configured and dimensioned to receive an expander, and wherein said second arm's at least one channel is configured and dimensioned to receive an expander.

15. The joint system of claim 14 wherein at least one bolt is configured and dimensioned to pass through said first arm's at least one locking receptacle to be inserted into said expander within said first arm's at least one channel, and, when the at least one bolt is rotated, said expander within said first arm's at least one channel applies a force to said first arm's at least one channel, wherein said first arm's at least one channel's expansion members expand.

16. The joint system of claim 14 wherein at least one bolt is configured and dimensioned to pass through at least one locking receptacle of said second arm to be inserted into said expander within said second arm's at least one channel, and, when the at least one bolt is rotated, said expander within said second arm's at least one channel applies a force to said second arm's at least one channel, wherein said second arm's at least one channel's expansion members expand.

17. The joint system of claim 14 wherein at least one bolt is configured and dimensioned to pass through said channel of said second arm to be inserted into said expander within said second arm's at least one channel, and, when the at least one bolt is rotated, said expander within said second arm's at least one channel applies a force to said second arm's at least one channel, wherein said second arm's at least one channel's expansion members expand and wherein the at least one bolt passes partially through at least one locking receptacle of said first arm.

18. The joint system of claim 12 wherein said reinforcement member comprises at least two hook structures.

19. The joint system of claim 18 further comprising at least two structural supports wherein one of said structural supports is configured and dimensioned to slidably engage and enclose said first arm wherein one of said structural supports engages with one of said hook structures of said reinforcement member to engage said first arm and wherein another of said structural supports is configured and dimensioned to slidably engage and enclose said second arm wherein another of said structural supports engages with another one of said hook structures of said reinforcement member to engage said second arm.

20. A joint system comprising:
at least one flat insert member comprising a decorative element;
said decorative element of said at least one flat insert member traversing the entire circumference of a seam of said at least one flat insert member;
said at least one flat insert member comprising a first arm and a second arm, each extending from said seam;
said at least one flat insert member's first and second arms each comprising hook structures at each end of said arms;
means for expanding each of said at least one flat insert member's first and second arms;
each of said at least one flat insert member's first and second arms configured and dimensioned to slidably engage and be enclosed by at least one flat structural support;
said at least one flat structural support comprising means for connecting with at least one vertical structural support;
at least one vertical insert member comprising a decorative element;
said decorative element of said at least one vertical insert member traversing the entire circumference of a seam of said at least one vertical insert member;
said at least one vertical insert member comprising a first arm and a second arm, each extending from said seam;
said at least one vertical insert member's first and second arms each comprising hook structures at each end of said arms;
means for expanding each of said at least one vertical insert member's first and second arms; and
each of said at least one vertical insert member's first and second arms configured and dimensioned to slidably engage and be enclosed by at least one vertical structural support.
